(19) United States
(12) Patent Application Publication
(10) Pub. No.: US 2022/0268877 A1
(43) Pub. Date: Aug. 25, 2022

(54) RADAR COMMUNICATION SYSTEM, IN-VEHICLE RADAR DEVICE, AND TRANSMISSION DEVICE

(71) Applicant: SONY GROUP CORPORATION, TOKYO (JP)

(72) Inventor: SHIGENORI UCHIDA, TOKYO (JP)

(21) Appl. No.: 17/628,287

(22) PCT Filed: May 27, 2020
(86) PCT No.: PCT/JP2020/020936

§ 371 Date: Jan. 19, 2022

(30) Foreign Application Priority Data
Jul. 31, 2019 (JP) 2019-140451

(51) Int. Cl. G01S 7/00; G01S 13/931; G01S 13/58

(52) U.S. Cl. CPC G01S 7/003; G01S 13/931; G01S 13/584; G01S 2013/9316

(57) ABSTRACT

Provided are a radar communication system capable of achieving road-to-vehicle communication or vehicle-to-vehicle communication with a simpler configuration, an in-vehicle radar device, and a transmission device. The radar communication system includes the in-vehicle radar device and the transmission device that is placed outside a vehicle. The in-vehicle radar device includes a millimeter wave radar sensor configured to transmit a transmission wave to outside of the vehicle and receive a reflected wave of the transmission wave, to thereby detect an object; a determination section configured to determine whether or not a physical relation between the object detected by the millimeter wave radar sensor and the vehicle is within an acceptable range; and an information extracting section configured to extract, when the physical relation is out of the acceptable range, information associated with a frequency characteristic of the reflected wave. The transmission device includes a reception section configured to receive the transmission wave; a modulated signal generating section configured to modulate, in association with information set in advance, a frequency characteristic of the transmission wave received by the reception section, to thereby generate a modulated signal; and a transmission section configured to transmit the modulated signal as part of the reflected wave.

### TECHNICAL FIELD

The present disclosure relates to a radar communication system, an in-vehicle radar device, and a transmission device.

### BACKGROUND ART

With regard to driving assistance devices for crash prevention, as means for detecting information regarding approaching vehicles or the like, there has been a road-to-vehicle communication technology (for example, see PTL 1).

### CITATION LIST

### Patent Literature

[PTL 1]
JP 2012-185084A

### SUMMARY

### Technical Problem

In a case where road-to-vehicle communication is performed using a driving assistance device, communication equipment is required in addition to sensors. When the driving assistance device incorporates the communication equipment, the driving assistance device has a more complicated configuration.

The present disclosure has been made in view of such circumstances and has an object to provide a radar communication system capable of achieving road-to-vehicle communication or vehicle-to-vehicle communication with a simpler configuration, an in-vehicle radar device, and a transmission device.

### Solution to Problem

According to an aspect of the present disclosure, there is provided a radar communication system including an in-vehicle radar device that is mounted in a vehicle; and a transmission device that is placed outside the vehicle. The in-vehicle radar device includes a millimeter wave radar sensor configured to transmit a transmission wave to outside of the vehicle and receive a reflected wave of the transmission wave, to thereby detect an object; a determination section configured to determine whether or not a physical relation between the object detected by the millimeter wave radar sensor and the vehicle is within an acceptable range set in advance; and an information extracting section configured to extract, when the physical relation is out of the acceptable range, information associated with a frequency characteristic of the reflected wave in advance. The transmission device includes a reception section configured to receive the transmission wave; a modulated signal generating section configured to modulate, in association with information set in advance, a frequency characteristic of the transmission wave received by the reception section, to thereby generate a modulated signal; and a transmission section configured to transmit the modulated signal as part of the reflected wave.

With this, the radar communication system can acquire information from the transmission device using the millimeter wave radar sensor. The in-vehicle radar device does not need additional communication equipment for acquiring information from the transmission device. With this, the radar communication system can achieve road-to-vehicle communication with a simpler configuration.

According to an aspect of the present disclosure, there is provided an in-vehicle radar device including a millimeter wave radar sensor configured to transmit a transmission wave to outside of a vehicle and receive a reflected wave of the transmission wave, to thereby detect an object; a determination section configured to determine whether or not a physical relation between the object detected by the millimeter wave radar sensor and the vehicle is within an acceptable range set in advance; and an information extracting section configured to extract, when the physical relation is out of the acceptable range, information associated with a frequency characteristic of the reflected wave in advance.

According to an aspect of the present disclosure, there is provided a transmission device including a reception section configured to receive a transmission wave that is transmitted to outside of a vehicle by an in-vehicle radar device; a modulated signal generating section configured to modulate, in association with information set in advance, a frequency characteristic of the transmission wave received by the reception section, to thereby generate a modulated signal; and a transmission section configured to transmit the modulated signal as part of a reflected wave of the transmission wave.

### BRIEF DESCRIPTION OF DRAWINGS

FIG. 1 is a schematic diagram illustrating a configuration example of a radar communication system according to Embodiment 1 of the present disclosure.

FIG. 2 is a block diagram illustrating a configuration example of an in-vehicle radar device 1 according to Embodiment 1 of the present disclosure.

FIG. 3 is a graph illustrating a distance and relative velocity detection method using the FMCW technique.

FIG. 4 is a block diagram illustrating a configuration example of a millimeter wave radar sensor according to Embodiment 1 of the present disclosure.

FIG. 5 is a block diagram illustrating a configuration example of a roadside transmission device according to Embodiment 1 of the present disclosure.

FIG. 6 is a flowchart illustrating an operation example of the radar communication system according to Embodiment 1 of the present disclosure.

FIG. 7 is a diagram of detection examples of physical relations according to Embodiment 1 of the present disclosure, illustrating distances and relative velocities (relative velocities=0) at time T and time T+ΔT.

FIG. 8 is another diagram of detection examples of physical relations according to Embodiment 1 of the present disclosure, illustrating distances and relative velocities (relative velocities=0) at time T and time T+ΔT.

FIG. 9 is a diagram of detection examples of physical relations according to Embodiment 1 of the present disclosure (modified example), illustrating distances and relative velocities (relative velocities=0) at time T and time T+ΔT.

FIG. 10 is a block diagram illustrating a configuration example of a roadside transmission device according to Embodiment 1 of the present disclosure (Modified Example 1).

FIG. 11 is a block diagram illustrating a configuration example of a roadside transmission device according to Embodiment 1 of the present disclosure (Modified Example 2).

FIG. 12 is a diagram of detection examples of physical relations according to Embodiment 2 of the present disclosure, illustrating distances and relative velocities (relative velocity>0 or relative velocity<0) at time T and time T+ΔT.

FIG. 13 is another diagram of detection examples of physical relations according to Embodiment 2 of the present disclosure, illustrating distances and relative velocities (relative velocity>0 or relative velocity<0) at time T and time T+ΔT.

FIG. 14 is a schematic diagram illustrating a configuration example of a radar communication system according to Embodiment 3 of the present disclosure.

### DESCRIPTION OF EMBODIMENTS

Now, embodiments of the present disclosure are described with reference to the drawings. Note that, in the illustration of the drawings, which are referred to in the following description, the same or similar components are denoted by the same or similar reference signs.

### Embodiment 1

First, a configuration example of a radar communication system 100 according to Embodiment 1 of the present disclosure is described.

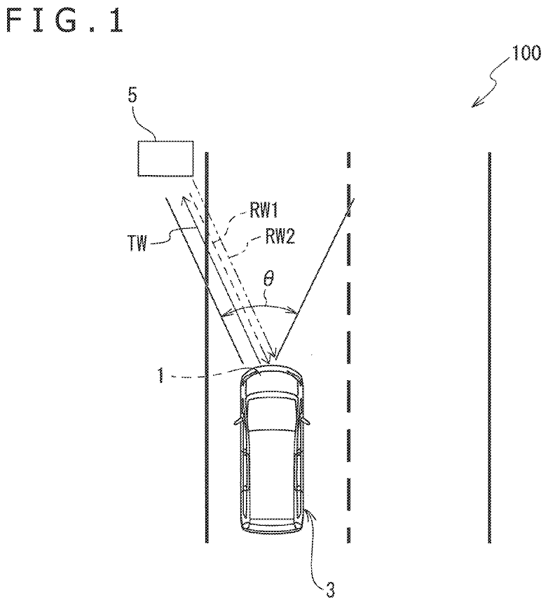

FIG. 1 is a schematic diagram illustrating the configuration example of the radar communication system 100 according to Embodiment 1 of the present disclosure. As illustrated in FIG. 1, the radar communication system 100 is a road-to-vehicle communication system using radio waves in the millimeter wave band, and includes an in-vehicle radar device 1 that is mounted in a vehicle 3 and a roadside transmission device 5 (an example of “transmission device” of the present disclosure) that is installed on a road on which the vehicle 3 travels. The radio waves in the millimeter wave band mean, for example, radio waves having a frequency of from 30 GHz or more to 300 GHz or less.

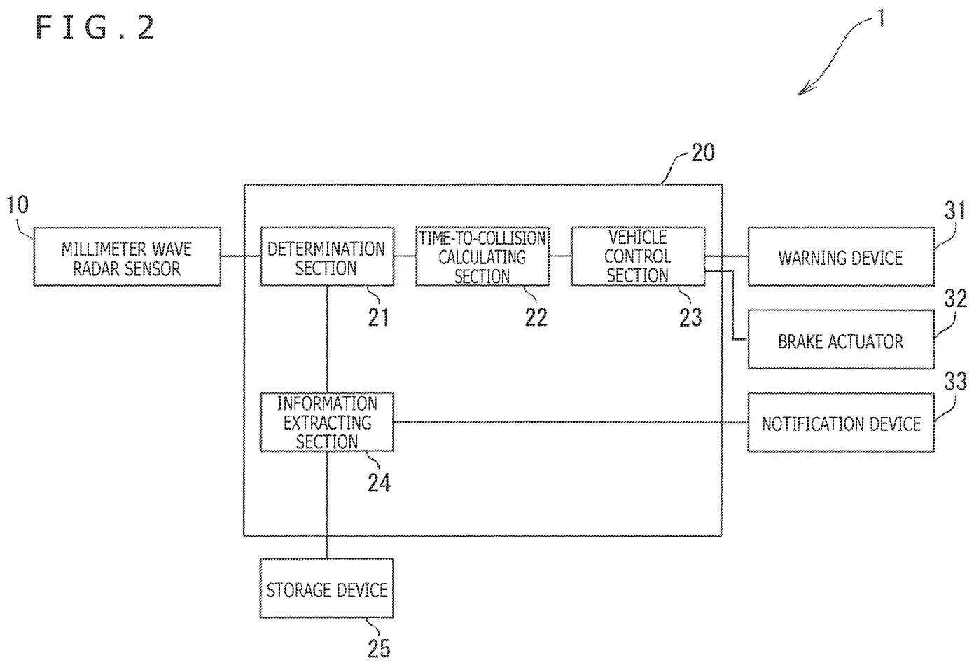

FIG. 2 is a block diagram illustrating a configuration example of the in-vehicle radar device 1 according to Embodiment 1 of the present disclosure. As illustrated in FIG. 2, the in-vehicle radar device 1 includes a millimeter wave radar sensor 10, an arithmetic processing device 20 configured to perform various types of arithmetic processing on the basis of signals output from the millimeter wave radar sensor 10, a storage device 25 connected to the arithmetic processing device 20, a warning device 31 configured to operate on the basis of signals output from the arithmetic processing device 20, a brake actuator 32 configured to operate on the basis of signals output from the arithmetic processing device 20, and a notification device 33 configured to operate on the basis of signals output from the arithmetic processing device 20.

As illustrated in FIG. 1, the millimeter wave radar sensor 10 transmits, from a front-end portion of the vehicle 3, a transmission wave TW toward a range having a predetermined angle θ in front of the vehicle 3 in the direction of travel at regular intervals and receives a reflected wave reflected from an object in front of the vehicle 3 in the direction of travel, to thereby detect the object. For example, in a case where there is another vehicle (not illustrated) in front of the vehicle 3 in the direction of travel, the millimeter wave radar sensor 10 receives a first reflected wave RW1 generated when the transmission wave TW is reflected on the surface of the other vehicle, to thereby detect the other vehicle that is an exemplary object. Note that, herein, the reflected wave received by the millimeter wave radar sensor 10 may be called received wave.

Further, in the case where the roadside transmission device 5 is installed in front of the vehicle 3 in the direction of travel as illustrated in FIG. 1, the millimeter wave radar sensor 10 receives the first reflected wave RW1 generated when the transmission wave TW is reflected on the surface of the roadside transmission device 5, to thereby detect the roadside transmission device 5 that is an exemplary object. Note that, as described later, the roadside transmission device 5 modulates the frequency of the received transmission wave TW to generate a modulated signal and transmits the generated modulated signal as a second reflected wave RW2. The millimeter wave radar sensor 10 also receives the second reflected wave RW2 as part of the reflected wave.

The millimeter wave radar sensor 10 detects the distance from the vehicle 3 to an object and the relative velocity between the vehicle 3 and the object using, for example, the FMCW (Frequency Modulated Continuous Wave) technique.

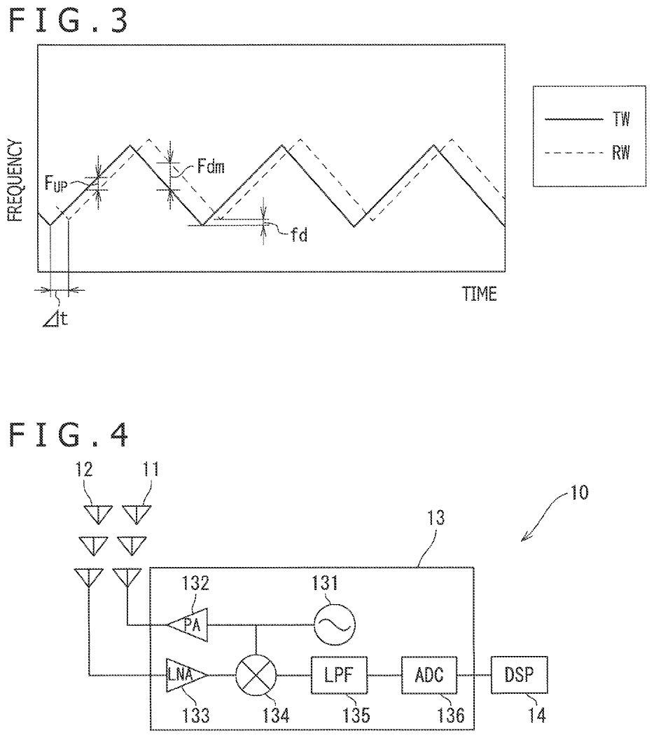

FIG. 3 is a graph illustrating a distance and relative velocity detection method using the FMCW technique. The horizontal axis of FIG. 3 indicates time and the vertical axis of FIG. 3 indicates frequency. The solid line of FIG. 3 indicates the transmission wave TW and the dashed line of FIG. 3 indicates a reflected wave RW. As illustrated in FIG. 3, the transmission wave TW in the FMCW technique is a chirp signal in which the frequency repeatedly monotonically increases and decreases in an alternate manner. The reflected wave RW of the transmission wave TW is also a chirp signal. In a chirp signal, the section in which the frequency monotonically increases is called up section and the section in which the frequency monotonically decreases is called down section.

The millimeter wave radar sensor 10 transmits, as the transmission wave TW, a continuous chirp signal in the millimeter wave band subjected to frequency modulation to have a triangle wave, for example, and receives, as the reflected wave RW, a chirp signal reflected from the direction in which the transmission wave TW has been transmitted. Then, the millimeter wave radar sensor 10 detects the frequencies of beat signals generated from the frequency difference between the transmission wave TW and the reflected wave RW. In the up section of the chirp signal, a beat signal having a frequency Fup is obtained from the frequency difference between the transmission wave TW and the reflected wave RW. In the down section of the chirp signal, a beat signal having a frequency Fdn is obtained from the frequency difference between the transmission wave TW and the reflected wave RW.

As illustrated in FIG. 3, a delay time Δt is generated between the transmission wave TW and the reflected wave RW. As described in Expressions (1) and (2) below, the frequencies Fup and Fdn are the sum of a frequency difference fr generated from the delay time Δt and a frequency shift fd due to the Doppler effect (hereinafter referred to as “Doppler frequency”), or the difference between the frequency difference fr and the Doppler frequency fd. Note that, the Doppler frequency fd is an example of “frequency characteristic of reflected wave” of the present disclosure.

Fup=fr−fd (1)

Fdn=fr+fd (2)

The frequency difference fr and the Doppler frequency fd can be expressed as Expressions (3) and (4) described below from Expressions (1) and (2) described above.

fr=(Fdn+Fup)/2 (3)

fd=(Fdn−Fup)/2 (4)

The frequency difference fr is proportional to the distance from the vehicle 3 to an object. The Doppler frequency fd is proportional to the relative velocity between the vehicle 3 and an object. In a case where the relative velocity is 0, the Doppler frequency fd is 0.

Note that, in the embodiment of the present disclosure, the velocity detection method may be, for example, a method that uses the up or down chirp sections of sawtooth waves to detect the Doppler velocity by focusing on the phase change between the chirp signals.

FIG. 4 is a block diagram illustrating a configuration example of the millimeter wave radar sensor 10 according to Embodiment 1 of the present disclosure. As illustrated in FIG. 4, the millimeter wave radar sensor 10 includes a transmission antenna 11, a reception antenna 12, an RF (Radio Frequency) front end 13 that is connected to the transmission antenna 11 and the reception antenna 12, and a digital signal processing section (DSP) 14 that is connected to the RF front end 13.

The RF front end 13 includes a chirp signal generating section 131, a power amplifier (PA) 132, a low-noise amplifier (LNA) 133, a mixer circuit 134, a low-pass filter (LPF) 135, and an A/D converter (ADC) 136. The transmission wave TW illustrated in FIG. 3 is generated by the chirp signal generating section 131, amplified by the power amplifier 132, and transmitted from the transmission antenna 11 to the outside. Further, the transmission wave TW is also transmitted to the mixer circuit 134. The first reflected wave RW1 and the second reflected wave RW2, which are illustrated in FIG. 1, are received by the reception antenna 12, amplified by the low-noise amplifier 133, and transmitted to the mixer circuit 134.

The mixer circuit 134 generates a first beat signal on the basis of the transmission wave TW and the first reflected wave RW1. Further, the mixer circuit 134 generates a second beat signal on the basis of the transmission wave TW and the second reflected wave RW2. The first beat signal and the second beat signal are transmitted to the A/D converter 136 through the low-pass filter 135 and converted from the analog signals to digital signals (hereinafter referred to as “AD conversion). The first beat signal and the second beat signal, which have been subjected to AD conversion by the A/D converter 136, are transmitted to the digital signal processing section 14.

The digital signal processing section 14 performs arithmetic processing based on Expressions (1) to (4) described above with regard to the first beat signal and the second beat signal. The digital signal processing section 14 calculates, from the first beat signal, the distance from the vehicle 3 to an object (for example, roadside transmission device 5 or another vehicle) and the relative velocity between the vehicle 3 and the object (for example, roadside transmission device 5 or another vehicle). Further, the digital signal processing section 14 calculates, from the second beat signal, the distance from the vehicle 3 to the roadside transmission device 5 and the relative velocity between the vehicle 3 and the roadside transmission device 5.

Note that, the distance and the relative velocity correspond to an example of “physical relation” of the present disclosure. The distance and relative velocity calculated from the first beat signal correspond to an example of “first physical relation” of the present disclosure. The distance and relative velocity calculated from the second beat signal correspond to an example of “second physical relation” of the present disclosure.

The arithmetic processing device 20 illustrated in FIG. 2 includes, as hardware, a CPU (Central Processing Unit), for example. The arithmetic processing device 20 includes, as functional sections that are executed by the CPU, a determination section 21, a time-to-collision calculating section 22, a vehicle control section 23, and an information extracting section 24.

The determination section 21 determines whether or not distance and relative velocity output from the millimeter wave radar sensor 10 are within an acceptable range set in advance. Examples of the case where the distance and the relative velocity are out of the acceptable range set in advance include a case where the distance has a variation equal to or more than a certain level although the relative velocity is zero and a case where the variation of the distance is zero although the relative velocity is equal to or more than a certain level.

The time-to-collision calculating section 22 calculates a time to collision between the vehicle 3 and an object on the basis of information regarding distance and relative velocity determined by the determination section 21 to be within the acceptable range. The vehicle control section 23 controls, when a time to collision calculated by the time-to-collision calculating section 22 is equal to or less than a first predetermined time (for example, three seconds) set in advance, the warning device 31 to operate to warn a driver of the vehicle 3. Further, the vehicle control section 23 controls, when a time to collision calculated by the time-to-collision calculating section 22 is equal to or less than a second predetermined time (for example, one second) set in advance, the brake actuator 32 to operate to decelerate the vehicle 3, thereby avoiding a collision with the object.

The information extracting section 24 acquires, in the case where the determination section 21 has determined that the distance and the relative velocity are out of the acceptable range, the Doppler frequency fd on which this determination is based. Then, the information extracting section 24 extracts information associated with the Doppler frequency fd in advance from the storage device 25. The information extracting section 24 outputs the information extracted from the storage device 25 to the notification device 33.

The storage device 25 includes, as hardware, a ROM (Read only memory), a RAM (Random access memory), a hard disk, and the like. The storage device stores a calculation program that is executed by the CPU, calculation results obtained by the calculation program, and various types of information. The various types of information include, as described in Table 1 below, information associated with the frequency characteristic of the second reflected wave RW2 (for example, the Doppler frequency fd calculated from the frequencies Fup and Fdn of the second beat signal) in advance.

The notification device 33 includes, for example, a display monitor and a speaker. The notification device 33 may at least partially share the display monitor and the speaker with the in-vehicle devices other than the notification device 33. The notification device 33 displays information transmitted from the information extracting section 24 on the display monitor as an image or characters or delivers the information from the speaker as sound, to thereby notify the driver of the vehicle 3 of the information.

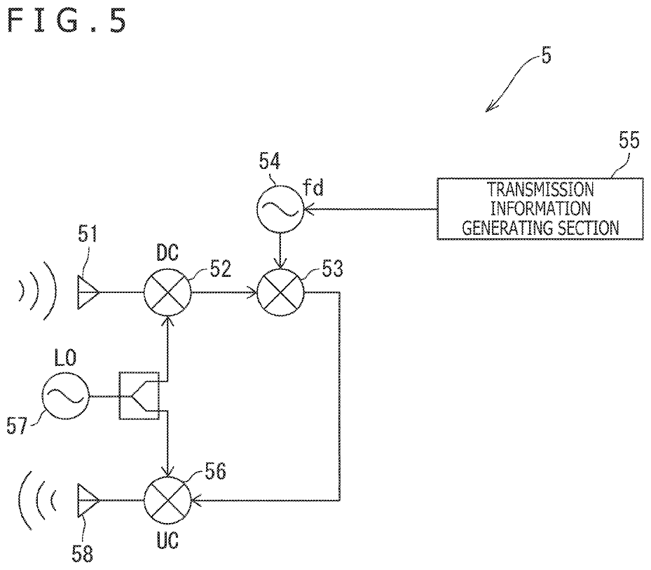

FIG. 5 is a block diagram illustrating a configuration example of the roadside transmission device 5 according to Embodiment 1 of the present disclosure.

As illustrated in FIG. 5, the roadside transmission device 5 includes a reception antenna 51 (an example of “reception section” of the present disclosure), a down converter (DC) 52, a mixer circuit 53, a conversion frequency generator 54, a transmission information generating section 55, an up converter (UC) 56, a local signal generator (LO) 57, and a transmission antenna 58 (an example of “transmission section” of the present disclosure). The mixer circuit 53 and the conversion frequency generator 54 correspond to an example of “modulated signal generating section” of the present disclosure.

The reception antenna 51 receives the transmission wave TW transmitted from the in-vehicle radar device 1. The down converter 52 lowers the frequency of the transmission wave TW received by the reception antenna 51. The transmission information generating section 55 generates transmission information (an example of “information” of the present disclosure). Examples of the transmission information according to Embodiment 1 are described in Table 1. As described in Table 1, as the transmission information from the roadside transmission device 5, road traffic information (traffic jam, accident, weather, road surface information, and others), installed object location information, and map information are exemplified. The transmission information generating section 55 is connected to a control device, which is not illustrated, by cables or wirelessly and generates transmission information when receiving a signal from the control device. The transmission information is associated with the frequency characteristic of the second reflected wave RW2 (for example, the Doppler frequency fd calculated from the frequencies Fup and Fdn of the second beat signal) on a one-to-one basis.

TABLE 1

| Doppler frequency fd [Hz] | 100 | 200 | 300 |
|---|---|---|---|
| Information | No danger ahead | Danger ahead | Stop |

The conversion frequency generator 54 generates, on the basis of transmission information generated by the transmission information generating section 55, a signal to be mixed with the transmission wave TW. For example, as described in Table 1, in the case of the transmission information “no danger ahead,” the conversion frequency generator 54 generates a signal having a conversion frequency for achieving the Doppler frequency fd of 100 Hz. In the case of the transmission information “danger ahead,” the conversion frequency generator 54 generates a signal having a conversion frequency for achieving the Doppler frequency fd of 200 Hz. In the case of the transmission information “stop,” the conversion frequency generator 54 generates a signal having a conversion frequency for achieving the Doppler frequency fd of 300 Hz.

The mixer circuit 53 mixes the signal of the transmission wave TW having a frequency reduced by the down converter 52 and a signal generated by the conversion frequency generator 54, to thereby generate a modulated signal having the modulated frequency of the transmission wave TW.

The up converter 56 increases the frequency of a modulated signal generated by the mixer circuit 53. The local signal generator 57 supplies a local signal (reference signal) to the down converter 52 and the up converter 56. The transmission antenna 58 transmits a modulated signal output from the up converter 56 to the vehicle 3 as the second reflected wave RW2.

As illustrated in FIG. 1, the in-vehicle radar device 1 mounted in the vehicle 3 transmits the transmission wave TW and receives, as the reflected wave of the transmission wave TW, the first reflected wave RW1 reflected on the surface of the roadside transmission device 5 and the second reflected wave RW2 transmitted from the roadside transmission device 5. The frequency of the second reflected wave RW2 is modulated from that of the first reflected wave RW1. The in-vehicle radar device 1 detects the frequency of a second beat signal generated from the frequency difference between the transmission wave TW and the second reflected wave RW2. For example, the in-vehicle radar device 1 detects the frequency Fup in the up section of the second beat signal and the frequency Fdn in the down section of the second beat signal. The in-vehicle radar device 1 can apply the frequencies Fup and Fdn of the second beat signal to Expression (4) described above to calculate the Doppler frequency fd of the second reflected wave RW2.

The Doppler frequency fd of the second reflected wave RW2 is higher than the Doppler frequency fd of the first reflected wave RW1 by the value of the frequency associated with the transmission information.

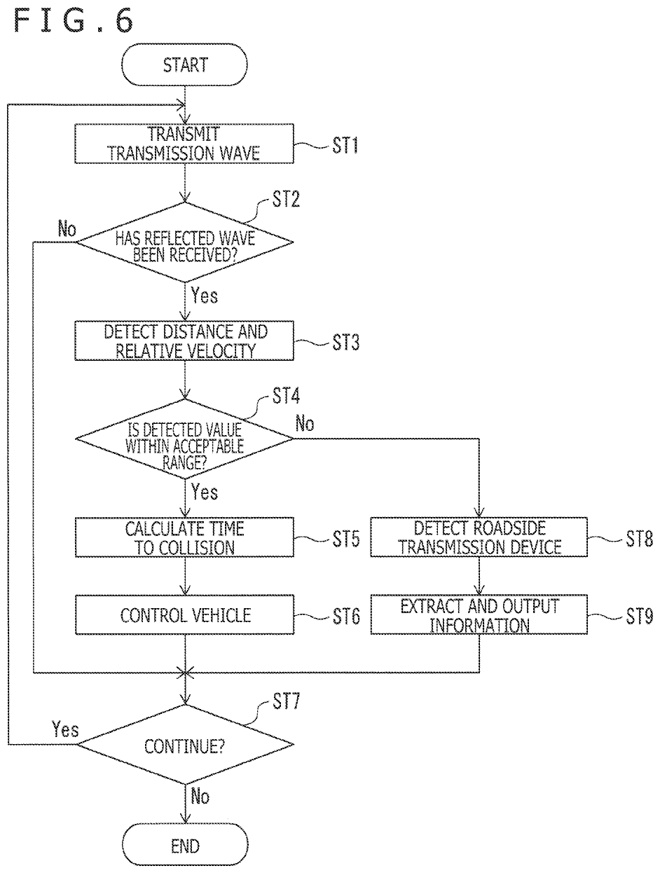

Further, the Doppler frequency fd of the second reflected wave RW2 is sufficiently higher than the Doppler frequency fd of the first reflected wave RW1 such that distance and relative velocity calculated on the basis of the transmission wave TW and the second reflected wave RW2 take values out of the acceptable range set in advance. That is, the Doppler frequency fd of the second reflected wave RW2 is sufficiently higher than the Doppler frequency fd of the first reflected wave RW1 such that it is determined in Step ST4 of FIG. 6, which is described later, that the distance-relative velocity relation is out of the acceptable range.

Next, an operation example of the radar communication system 100 according to Embodiment 1 of the present disclosure is described.

FIG. 6 is a flowchart illustrating the operation example of the radar communication system 100 according to Embodiment 1 of the present disclosure. In FIG. 6, the millimeter wave radar sensor 10 transmits, from the front-end portion of the vehicle 3, the transmission wave TW toward the range having the predetermined angle θ in front of the vehicle 3 in the direction of travel at the regular intervals (Step ST1). Next, the millimeter wave radar sensor 10 determines whether or not the reflected wave RW has been received (Step ST2). In a case where it is determined in Step ST2 that the reflected wave RW has been received (Step ST2; Yes), the processing proceeds to Step ST3. In a case where it is determined in Step ST2 that the reflected wave RW has not been received (Step ST2; No), the processing proceeds to Step ST7.

In Step ST3, the millimeter wave radar sensor 10 generates a beat signal that is the frequency difference between the transmission wave TW and the reflected wave RW, and calculates the frequency Fup in the up section of the beat signal and the frequency Fdn in the down section of the beat signal. Next, the millimeter wave radar sensor 10 calculates, from the frequencies Fup and Fdn of the beat signal, the frequency difference fr generated from the delay time Δt between the transmission wave TW and the reflected wave RW, and the Doppler frequency fd. The frequency difference fr and the Doppler frequency fd, which have been calculated, are transmitted to the arithmetic processing device 20. The arithmetic processing device 20 detects, on the basis of the frequency difference fr and the Doppler frequency fd, the distance between the vehicle 3 and the object and the relative velocity between the vehicle 3 and the object.

Next, the arithmetic processing device 20 determines whether or not the distance and the relative velocity, which are the detected values, are within the acceptable range set in advance (Step ST4).

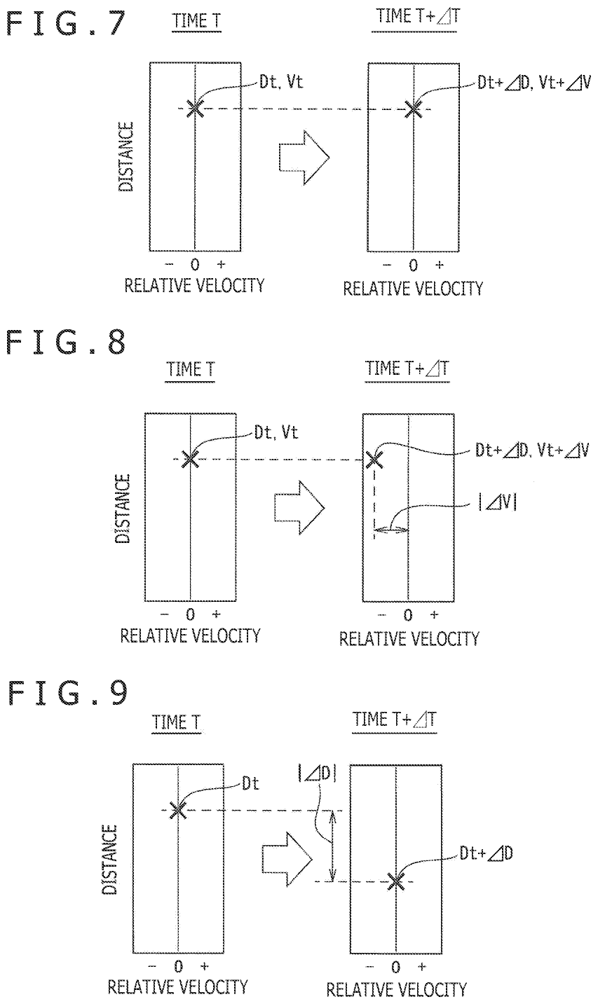

FIG. 7 and FIG. 8 are each a diagram of detection examples of physical relations according to Embodiment 1 of the present disclosure, illustrating distances and relative velocities (relative velocities=0) at time T and time T+ΔT. FIG. 7 illustrates a case where the distance and the relative velocity are within the acceptable range. FIG. 8 illustrates a case where the distance and the relative velocity are out of the acceptable range. In each of FIG. 7 and FIG. 8, the left graph is a graph at time T and the right graph is a graph at time T+ΔT that comes after ΔT has elapsed from time T.

As illustrated in FIG. 7 and FIG. 8, in the case where the relative velocities at time T and time T+ΔT are zero (0), the vehicle 3 does not move relative to the roadside transmission device 5. Thus, as illustrated in FIG. 7, a distance Dt between the vehicle 3 and the object at time T and a distance Dt+ΔD between the vehicle 3 and the object at time T+ΔT take the same value. A relative velocity Vt between the vehicle 3 and the object at time T and a relative velocity Vt+ΔV between the vehicle 3 and the object at time T+ΔT also take the same value. That is, ΔD and ΔV are zero. In such a case, the distance and the relative velocity are consistent with each other, so that the arithmetic processing device 20 determines that the distance and the relative velocity are within the acceptable range (Step ST4; Yes). The reflected wave RW having distance and relative velocity determined to be within the acceptable range is the first reflected wave RW1. With this determination, the arithmetic processing device 20 detects the object.

Next, the arithmetic processing device 20 calculates a time to collision with the object (Step ST5). Then, the arithmetic processing device 20 controls the vehicle before the calculated time to collision elapses to avoid a collision between the vehicle 3 and the object (Step ST6). This avoidance operation includes causing, by the arithmetic processing device 20, the warning device 31 to operate to warn the driver of the vehicle 3 and causing, by the arithmetic processing device 20, the brake actuator 32 to operate to decelerate the vehicle 3. After that, the processing proceeds to Step ST7.

Meanwhile, as illustrated in FIG. 8, in the case where although the actual relative velocities at time T and time T+ΔT are zero, ΔV is not zero and the absolute value of ΔV is larger than a value set in advance, the distance and the relative velocity are inconsistent with each other. In such a case, the arithmetic processing device 20 determines that the distance-relative velocity relation is out of the acceptable range (Step ST4; No). That is, the arithmetic processing device 20 determines that a physically impossible movement has been detected. The reflected wave RW to which a determination is made as No in Step ST4 is the second reflected wave RW2. With this determination, the arithmetic processing device 20 detects the roadside transmission device 5 (Step ST8).

Note that, the vehicle 1 can detect vehicle speed from information obtained by a speedometer mounted on the vehicle 1. The vehicle speed may be output from the speedometer to the arithmetic processing device 20 (for example, determination section 21). The arithmetic processing device 20 can determine whether or not the vehicle 1 is parked on the basis of the vehicle speed. In a case where the absolute value of ΔV is larger than the value set in advance although the vehicle 1 is parked, the arithmetic processing device 20 may determine that the distance-relative velocity relation is out of the acceptable range.

After Step ST8, the arithmetic processing device 20 extracts information associated in advance with the reflected wave having distance and the relative velocity determined to be out of the acceptable range (that is, second reflected wave RW2) (Step ST9). For example, in a case where the Doppler frequency fd of the second reflected wave RW2 is 100 Hz, as described in Table 1 above, the arithmetic processing device 20 extracts, from the storage device 25, the information “danger ahead” corresponding to 100 Hz. Then, the arithmetic processing device 20 transmits the information “danger ahead,” which has been extracted from the storage device 25, to the notification device 33.

The notification device 33 notifies the driver of the vehicle 3 of the information transmitted from the arithmetic processing device 20. For example, the notification device 33 displays the information on the display monitor of the notification device 33 or delivers the information from the speaker of the notification device 33 as sound. With this, the driver of the vehicle 3 can recognize the transmission information transmitted from the roadside transmission device 5. After that, the processing proceeds to Step ST9.

In Step ST9, the arithmetic processing device 20 determines whether or not to continue the object detection operation by the radar communication system 100. In a case where the detection operation continues, the processing proceeds to Step ST1, and in a case where the detection operation does not continue, the flowchart of FIG. 6 ends.

As described above, the radar communication system 100 according to Embodiment 1 of the present disclosure includes the in-vehicle radar device 1 that is mounted in the vehicle 3 and the roadside transmission device 5 that is placed outside the vehicle 3. The in-vehicle radar device 1 includes the millimeter wave radar sensor 10 configured to transmit the transmission wave TW to the outside of the vehicle 3 and receive the reflected wave RW of the transmission wave TW, to thereby detect an object, the determination section 21 configured to determine whether or not the physical relation (for example, distance and relative velocity) between the object detected by the millimeter wave radar sensor 10 and the vehicle 3 is within the acceptable range set in advance, and the information extracting section 24 configured to extract, when the physical relation is out of the acceptable range, transmission information associated with the frequency characteristic of the reflected wave RW in advance. The roadside transmission device 5 includes the reception antenna 51 configured to receive the transmission wave TW, the conversion frequency generator 54 and the mixer circuit 53 that modulate, in association with transmission information set in advance, the frequency of the transmission wave TW received by the reception antenna 51, to thereby generate a modulated signal, and the transmission antenna 58 configured to transmit the modulated signal as part of the reflected wave RW.

For example, the reflected wave RW includes the first reflected wave RW1 that is generated when the transmission wave TW is reflected on the surface of the roadside transmission device 5, and the second reflected wave RW2 that is generated when a modulated signal is transmitted from the transmission antenna 58 of the roadside transmission device 5. The physical relation includes the first physical relation that is calculated on the basis of the transmission wave TW and the first reflected wave RW1, and the second physical relation that is calculated on the basis of the transmission wave TW and the second reflected wave RW2. The determination section 21 determines whether or not each of the first physical relation and the second physical relation is within the acceptable range. A modulated signal that is transmitted as the second reflected wave RW2 is generated to have a second physical relation out of the acceptable range.

With this, the in-vehicle radar device 1 can distinguish between the first reflected wave RW1 and the second reflected wave RW2 on the basis of the result of a determination by the determination section 21. The in-vehicle radar device 1 can detect the roadside transmission device 5 by receiving the second reflected wave RW2. The in-vehicle radar device 1 can acquire, by detecting the Doppler frequency fd of the second reflected wave RW2, transmission information associated with the Doppler frequency fd in advance (for example, information such as “no danger ahead,” “danger ahead,” or “stop” as described in Table 1).

With this, the radar communication system 100 can acquire transmission information from the roadside transmission device 5 using the millimeter wave radar sensor 10 for measuring the physical relation (for example, distance and relative velocity) between an object and the vehicle. The in-vehicle radar device 1 does not need additional communication equipment for acquiring transmission information from the roadside transmission device 5. The roadside transmission device 5 receives the transmission wave TW and transmits the second reflected wave RW2 having a physical contradiction to the in-vehicle radar device 1, thereby being capable of transmitting transmission information to the in-vehicle radar device 1. With this, the radar communication system 100 can achieve road-to-vehicle communication with a simpler configuration.

Note that, in Embodiment 1 described above, as the physical relation between the object and the vehicle 3 detected by the millimeter wave radar sensor 10, the distance and the relative velocity are exemplified. Further, as the case where the distance and the relative velocity are out of the acceptable range set in advance, the case where the distance has a variation equal to or more than the certain level although the relative velocity is zero and the case where the variation of the distance is zero although the relative velocity is equal to or more than the certain level are exemplified. However, in the embodiment of the present disclosure, the physical relation is not limited to the distance and the relative velocity.

For example, in the embodiment of the present disclosure, the physical relation may only include the relative velocity. In this case, as the case where the physical relation is out of the acceptable range set in advance, a case where a relative velocity that is impossibly high from the calculation based on the traveling performance of the vehicle 3 and another vehicle is detected is given. Also in such an aspect, the radar communication system 100 can receive transmission information from the roadside transmission device 5 using the millimeter wave radar sensor 10.

### Modified Example

In Embodiment 1 described above, it is described that, in the case where although the actual relative velocities at time T and time T+ΔT are zero, ΔV is not zero and the absolute value of ΔV is larger than the value set in advance, the arithmetic processing device 20 determines that the distance-relative velocity relation is out of the acceptable range (Step ST4; No). However, in the embodiment of the present disclosure, the material for determining the distance-relative velocity relation is not limited to ΔV. The material for determining the distance-relative velocity relation may be ΔD.

FIG. 9 is a diagram of detection examples of physical relations according to Embodiment 1 of the present disclosure (modified example), illustrating distances and relative velocities (relative velocities=0) at time T and time T+ΔT. As illustrated in FIG. 9, in the case where although the relative velocities at time T and time T+ΔT are zero, ΔD is not zero and is larger than a value set in advance, the distance and the relative velocity are inconsistent with each other. In such a case, the arithmetic processing device 20 may determine that the distance-relative velocity relation is out of the acceptable range (Step ST4; No). With this determination, the arithmetic processing device 20 may detect the roadside transmission device 5 (Step ST8).

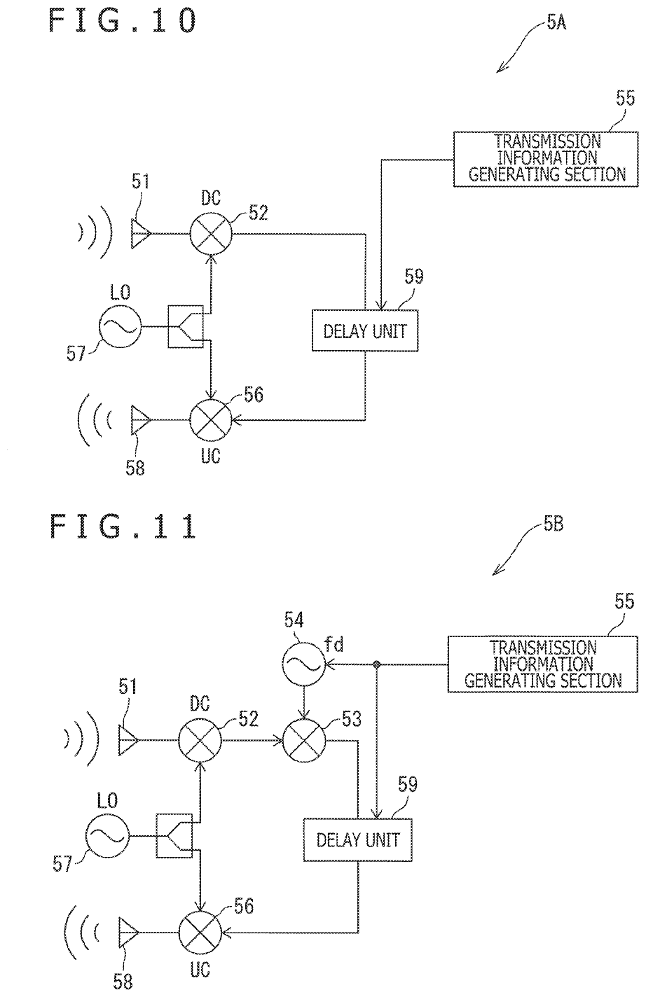

FIG. 10 is a block diagram illustrating a configuration example of a roadside transmission device 5A according to Embodiment 1 of the present disclosure (Modified Example 1). As illustrated in FIG. 10, the roadside transmission device 5A has the configuration of the above-mentioned roadside transmission device 5 excluding the mixer circuit 53 and the conversion frequency generator 54 and includes a delay unit 59 placed between the down converter 52 and the up converter (UC) 56. Further, in the roadside transmission device 5A, transmission information is supplied from the transmission information generating section 55 to the delay unit 59. With this, the delay unit 59 can delay signals output from the down converter 52. The delay unit 59 can delay, on the basis of the transmission information, a signal such that ΔD takes a value larger than the value set in advance.

Further, in the embodiment of the present disclosure, FIG. 5 and FIG. 10 described above may be combined. FIG. 11 is a block diagram illustrating a configuration example of a roadside transmission device 5B according to Embodiment 1 of the present disclosure (Modified Example 2). As illustrated in FIG. 11, the roadside transmission device 5B has the combined configuration of the roadside transmission devices 5 and 5A described above. With this, the arithmetic processing device 20 can determine the distance-relative velocity relation on the basis of one of or both ΔV and ΔD.

### Embodiment 2

In Embodiment 1 described above, as illustrated in FIG. 7 and FIG. 8, the case where the relative velocities at time T and time T+ΔT are zero (that is, the case where the vehicle 3 does not move relative to the roadside transmission device 5) is described. However, in the radar communication system 100, the vehicle 3 to which transmission information is transmitted from the roadside transmission device 5 is not necessarily parked. In the radar communication system 100, the vehicle 3 to which transmission information is transmitted from the roadside transmission device 5 may be traveling. Also in this case, the radar communication system 100 operates by following the flowchart of FIG. 6, for example.

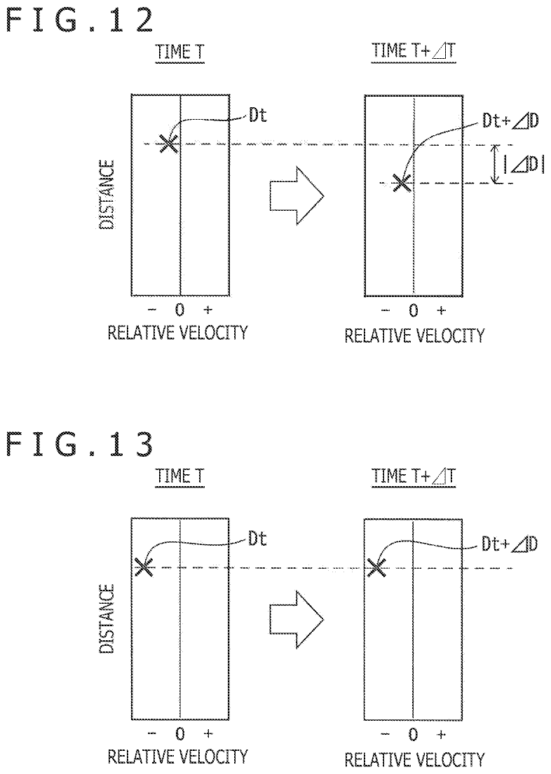

FIG. 12 and FIG. 13 are each a diagram of detection examples of physical relations according to Embodiment 2 of the present disclosure, illustrating distances and relative velocities (relative velocity>0 or relative velocity<0) at time T and time T+ΔT. FIG. 12 illustrates a case where the distance-relative velocity relation is within the acceptable range. FIG. 13 illustrates a case where the distance and the relative velocity are out of the acceptable range. In each of FIG. 12 and FIG. 13, the left graph is a graph at time T and the right graph is a graph at time T+ΔT.

As illustrated in FIG. 12 and FIG. 13, in the case where the relative velocities at time T and time T+ΔT are negative (−), the vehicle 3 travels toward the roadside transmission device 5. Thus, as illustrated in FIG. 12, the distance Dt+ΔD between the vehicle 3 and the object at time T+ΔT takes a smaller value than the distance Dt between the vehicle 3 and the object at time T. That is, ΔD is negative. Further, |ΔD| that is the absolute value of ΔD takes a value indicating that the distance and the relative velocity are consistent with each other. In such a case, the arithmetic processing device 20 determines that the distance and the relative velocity are within the acceptable range (Step ST4 of FIG. 6; Yes).

Meanwhile, as illustrated in FIG. 13, in the case where although the relative velocities at time T and time T+ΔT are negative, ΔD is not negative and is zero, for example, the distance and the relative velocity are inconsistent with each other. In such a case, the arithmetic processing device 20 determines that the distance and the relative velocity are out of the acceptable range (Step ST4 of FIG. 6; No).

Also in the second embodiment described above, the in-vehicle radar device 1 does not need additional communication equipment for acquiring transmission information from the roadside transmission device 5. Thus, also in the second embodiment, the radar communication system 100 can achieve road-to-vehicle communication with a simpler configuration.

### Embodiment 3

In Embodiments 1 and 2 described above, road-to-vehicle communication in which information is transmitted from the roadside transmission device 5 to the vehicle 3 is described. However, the radar communication system according to the present disclosure is not limited to road-to-vehicle communication. The radar communication system according to the present disclosure may be applied to vehicle-to-vehicle communication in which vehicles communicate with each other.

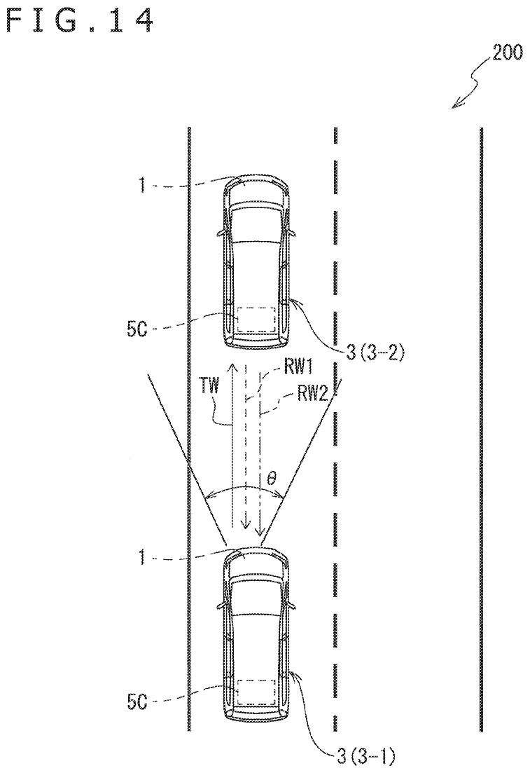

FIG. 14 is a schematic diagram illustrating a configuration example of a radar communication system 200 according to Embodiment 3 of the present disclosure. As illustrated in FIG. 14, the radar communication system 200 is a vehicle-to-vehicle communication system and includes the in-vehicle radar device 1 that is mounted in the vehicle 3 and an in-vehicle transmission device 5C (an example of “transmission device” of the present disclosure) that is mounted in the vehicle 3. The in-vehicle transmission device 5C has the same configuration as the roadside transmission device 5 illustrated in FIG. 5.

The millimeter wave radar sensor 10 of the in-vehicle radar device 1 is installed on the front-end portion of the vehicle 3. The reception antenna 51 and the transmission antenna 58 of the in-vehicle transmission device 5C are installed on the rear-end portion of the vehicle 3. With this, in a case where there are the vehicles 3, that is, a vehicle 3-1 and a vehicle 3-2 in front of the vehicle 3-1 in the direction of travel, the in-vehicle radar device 1 mounted in the vehicle 3-1 can perform the transmission of the transmission wave TW and the reception of the first reflected wave RW1 and the second reflected wave RW2 with respect to the in-vehicle transmission device 5C mounted in the vehicle 3-2.

Examples of the transmission information according to Embodiment 3 are described in Table 2. As described in Table 2, as the transmission information from the in-vehicle transmission device 5C, vehicle control information (acceleration, deceleration, lane change, and others) is exemplified. For example, the transmission information generating section 55 is connected to the engine control unit (ECU) or the like of the vehicle 3 by cables or wirelessly and generates transmission information when receiving a signal from the ECU or the like. Also in the third embodiment, the transmission information is associated with the frequency characteristic of the second reflected wave RW2 (for example, the Doppler frequency fd calculated from the frequencies Fup and Fdn of the second beat signal) on a one-to-one basis.

TABLE 2

| Doppler frequency fd [Hz] | 150 | 250 | 350 |
|---|---|---|---|
| Information | Acceleration | Deceleration | Course change |

As described above, the radar communication system 200 according to Embodiment 3 of the present disclosure includes the in-vehicle radar device 1 that is mounted in the vehicle 3-1 and the in-vehicle transmission device 5C that is mounted in the vehicle 3-2. The in-vehicle radar device 1 that is mounted in the vehicle 3-1 includes the millimeter wave radar sensor 10 configured to transmit the transmission wave TW toward the range in front of the vehicle 3 in the direction of travel and receive the reflected wave RW of the transmission wave TW, to thereby detect the vehicle 3-2, the determination section 21 configured to determine whether or not the physical relation between the vehicle 3-2 detected by the millimeter wave radar sensor 10 and the vehicle 3-1 is within the acceptable range set in advance, and the information extracting section 24 configured to extract, when the physical relation is out of the acceptable range, transmission information associated with the frequency characteristic of the reflected wave RW in advance. The in-vehicle transmission device 5C that is mounted in the vehicle 3-2 includes the reception antenna 51 configured to receive the transmission wave TW, the conversion frequency generator 54 and the mixer circuit 53 that modulate, in association with transmission information set in advance, the frequency of the transmission wave TW received by the reception antenna 51, to thereby generate a modulated signal, and the transmission antenna 58 configured to transmit the modulated signal as part of the reflected wave RW (for example, second reflected wave RW2).

With this, the radar communication system 200 can acquire transmission information (for example, information such as “acceleration,” “deceleration,” or “course change” as described in Table 2) from the in-vehicle transmission device 5C using the millimeter wave radar sensor 10. The in-vehicle radar device 1 does not need additional communication equipment for acquiring transmission information from the in-vehicle transmission device 5C. With this, the radar communication system 200 can achieve vehicle-to-vehicle communication with a simpler configuration.

### Other Embodiments

While the present disclosure has been described above in the form of Embodiments 1 to 3, it is not to be understood that the descriptions and drawings that constitute parts of the disclosure limit the present disclosure. Various alternative embodiments, examples, and operational technologies will become apparent from the disclosure to those skilled in the art. The present technology includes various embodiments and the like not described herein as a matter of course. At least one of various types of omission, replacement, and modification of the components can be made without departing from the gist of Embodiments 1 to 3 described above. Any combination of Embodiments 1 to 3 is possible. Further, the effects described herein are only exemplary and not limitative, and other effects may be provided.

Note that, the present disclosure can also take the following configurations.

(1)

A radar communication system including:
an in-vehicle radar device that is mounted in a vehicle; and
a transmission device that is placed outside the vehicle,
in which the in-vehicle radar device includes
   a millimeter wave radar sensor configured to transmit a transmission wave to outside of the vehicle and receive a reflected wave of the transmission wave, to thereby detect an object,
   a determination section configured to determine whether or not a physical relation between the object detected by the millimeter wave radar sensor and the vehicle is within an acceptable range set in advance, and
   an information extracting section configured to extract, when the physical relation is out of the acceptable range, information associated with a frequency characteristic of the reflected wave in advance, and
the transmission device includes
   a reception section configured to receive the transmission wave,
   a modulated signal generating section configured to modulate, in association with information set in advance, a frequency characteristic of the transmission wave received by the reception section, to thereby generate a modulated signal, and
   a transmission section configured to transmit the modulated signal as part of the reflected wave.
      (2)

The radar communication system according to Item (1),
in which the reflected wave includes
   a first reflected wave that is generated when the transmission wave is reflected on a surface of the transmission device, and
   a second reflected wave that is generated when the modulated signal is transmitted from the transmission section,
the physical relation includes
   a first physical relation that is calculated based on the transmission wave and the first reflected wave, and
   a second physical relation that is calculated based on the transmission wave and the second reflected wave, and
the determination section determines whether or not each of the first physical relation and the second physical relation is within the acceptable range.
   (3)

The radar communication system according to Item (2), in which the modulated signal generating section generates the modulated signal such that the second physical relation is out of the acceptable range.

(4)

The radar communication system according to any one of Items (1) to (3), in which the physical relation includes a relation between a distance from the vehicle to the object and a relative velocity between the vehicle and the object.

(5)

The radar communication system according to any one of Items (1) to (4), in which the transmission device includes a roadside transmission device installed on a road on which the vehicle travels.

(6)

The radar communication system according to any one of Items (1) to (4),
in which the object includes another vehicle in front of the vehicle in a direction of travel, and
the transmission device includes an in-vehicle transmission device mounted in the another vehicle.
   (7)

An in-vehicle radar device including:
a millimeter wave radar sensor configured to transmit a transmission wave to outside of a vehicle and receive a reflected wave of the transmission wave, to thereby detect an object;
a determination section configured to determine whether or not a physical relation between the object detected by the millimeter wave radar sensor and the vehicle is within an acceptable range set in advance; and
an information extracting section configured to extract, when the physical relation is out of the acceptable range, information associated with a frequency characteristic of the reflected wave in advance.
   (8)

A transmission device including:
a reception section configured to receive a transmission wave that is transmitted to outside of a vehicle by an in-vehicle radar device;
a modulated signal generating section configured to modulate, in association with information set in advance, a frequency characteristic of the transmission wave received by the reception section, to thereby generate a modulated signal; and
a transmission section configured to transmit the modulated signal as part of a reflected wave of the transmission wave.

### REFERENCE SIGNS LIST

1: In-vehicle radar device
3: Vehicle
3-1: Vehicle
3-2: Vehicle
5, 5A, 5B: Roadside transmission device
5C: In-vehicle transmission device
10: Millimeter wave radar sensor
11, 58: Transmission antenna
12, 51: Reception antenna
13: RF front end
14: Digital signal processing section
20: Arithmetic processing device
21: Determination section
22: Time-to-collision calculating section
23: Vehicle control section
24: Information extracting section
25: Storage device
31: Warning device
32: Brake actuator
33: Notification device
52: Down converter
53: Mixer circuit
54: Conversion frequency generator
55: Transmission information generating section
56: Up converter
57: Local signal generator
100: Radar communication system
131: Chirp signal generating section
132: Power amplifier
133: Low-noise amplifier
134: Mixer circuit
135: Low-pass filter
136: A/D converter
200: Radar communication system
fd: Doppler frequency
Fdn: Frequency
fr: Frequency difference
Fup: Frequency
RW: Reflected wave
RW1: First reflected wave
RW2: Second reflected wave
TW: Transmission wave

1. A radar communication system comprising:
an in-vehicle radar device that is mounted in a vehicle; and
a transmission device that is placed outside the vehicle,
wherein the in-vehicle radar device includes
a millimeter wave radar sensor configured to transmit a transmission wave to outside of the vehicle and receive a reflected wave of the transmission wave, to thereby detect an object,
a determination section configured to determine whether or not a physical relation between the object detected by the millimeter wave radar sensor and the vehicle is within an acceptable range set in advance, and
an information extracting section configured to extract, when the physical relation is out of the acceptable range, information associated with a frequency characteristic of the reflected wave in advance, and
the transmission device includes
a reception section configured to receive the transmission wave,
a modulated signal generating section configured to modulate, in association with information set in advance, a frequency characteristic of the transmission wave received by the reception section, to thereby generate a modulated signal, and
a transmission section configured to transmit the modulated signal as part of the reflected wave.

2. The radar communication system according to claim 1,
wherein the reflected wave includes
a first reflected wave that is generated when the transmission wave is reflected on a surface of the transmission device, and
a second reflected wave that is generated when the modulated signal is transmitted from the transmission section,
the physical relation includes
a first physical relation that is calculated based on the transmission wave and the first reflected wave, and
a second physical relation that is calculated based on the transmission wave and the second reflected wave, and
the determination section determines whether or not each of the first physical relation and the second physical relation is within the acceptable range.

3. The radar communication system according to claim 2, wherein the modulated signal generating section generates the modulated signal such that the second physical relation is out of the acceptable range.

4. The radar communication system according to claim 1, wherein the physical relation includes a relation between a distance from the vehicle to the object and a relative velocity between the vehicle and the object.

5. The radar communication system according to claim 1, wherein the transmission device includes a roadside transmission device installed on a road on which the vehicle travels.

6. The radar communication system according to claim 1,
wherein the object includes another vehicle in front of the vehicle in a direction of travel, and
the transmission device includes an in-vehicle transmission device mounted in the another vehicle.

7. An in-vehicle radar device comprising:
a millimeter wave radar sensor configured to transmit a transmission wave to outside of a vehicle and receive a reflected wave of the transmission wave, to thereby detect an object;
a determination section configured to determine whether or not a physical relation between the object detected by the millimeter wave radar sensor and the vehicle is within an acceptable range set in advance; and
an information extracting section configured to extract, when the physical relation is out of the acceptable range, information associated with a frequency characteristic of the reflected wave in advance.

8. A transmission device comprising:
a reception section configured to receive a transmission wave that is transmitted to outside of a vehicle by an in-vehicle radar device;
a modulated signal generating section configured to modulate, in association with information set in advance, a frequency characteristic of the transmission wave received by the reception section, to thereby generate a modulated signal; and
a transmission section configured to transmit the modulated signal as part of a reflected wave of the transmission wave.
